(19) United States
(12) Patent Application Publication
(10) Pub. No.: US 2010/0233997 A1
(43) Pub. Date: Sep. 16, 2010

(54) System, method and implementation of providing dynamic multi-media ringtone to called party prior to answer a call

(76) Inventor: Wanchun Hou, Fremont, CA (US)

Correspondence Address: DAVID AND RAYMOND PATENT FIRM, 108 N. YNEZ AVE., SUITE 128, MONTEREY PARK, CA, 91754, US

(21) Appl. No.: 12/660,733

(22) Filed: Mar. 2, 2010

(30) Foreign Application Priority Data
Mar. 12, 2009 (CN) 200910079474.9

(51) Int. Cl. H04L 12/58; H04B 7/005

(52) U.S. Cl. 455/412.1; 370/310

(57) ABSTRACT

The present invention provides the user of the phone terminals, especially the users of 3G mobile communication terminals a novel dynamic multimedia sing service, enable the users of broadband phone terminals to enjoy the multimedia ring message from the network by their phone terminals.

### BACKGROUND OF THE PRESENT INVENTION

1. Field of Invention

The present invention relates to telecommunication, and more particularly to system and method of providing dynamic ringtone to called terminal prior to answer the phone.

2. Description of Related Arts

In the current telecommunication field, personalized ringtone has become a very popular service. But with the advent of 3G mobile communication and the development of IP service, the personalized ringtone service will be improved to service involving video capabilities. The personalized ringtone service is provided to callers. When the caller calls, he/she can hear the personalized ringtone. The disadvantages of this service are: when is called, the called terminal does not display the personalized ringtone.

It is believed by the inventor, to provide dynamic ring service to the called party via 3G and 4G, or the follow-up networks will effectively utilize the advantage of the wireless broadband characteristics, wherein the service is when the called party receives a paging message including the ring information, the called terminal setup a multi medium data link with the multi medium ring server, and play the received multi medium data stream or resource. This dynamic ringtone service is called dynamic ringtone by the invention.

### SUMMARY OF THE PRESENT INVENTION

An object of this invention is to provide a system and method to dynamically play ringtone before the called terminal response, so as to provide dynamic multimedia ring information services to called party on the wireless broadband mobile communication network.

The series of solutions of the present invention are:

A phone terminal, which plays ringtone dynamically prior to answer the phone, is a phone terminal with a dynamic ringtone function added on a standard phone terminal. The dynamic ringtone system is a dynamic ringtone function, wherein when the user of the phone terminal, i.e. the called party, receives the session message from the telecommunication network, the dynamic ringtone system determines whether the session message contains multimedia ringtone service flag section. For the session message which contains multimedia ringtone service flag, the multimedia ringtone information is obtained from the target address designated to play the multimedia ringtone at the phone terminal. Therefore, the phone terminal will play the multimedia ringtone instead of playing the preset ringtone at the phone terminal. For the session message which does not contain multimedia ringtone service flag, the phone terminal will play the preset ringtone saved in the phone terminal by the user.

A mobile communication system where mobile phone terminal plays multimedia ringtone dynamically prior to answer the phone, comprising:
a mobile communication network providing communication links between mobile phone terminals;
a mobile communication access gateway, connecting the mobile communication wireless network and the mobile communication network, to provide the service of communicatively connecting mobile phone terminals to the mobile communication network via mobile communication wireless network;
a plurality of mobile phone terminals connected with the mobile communication access gateway via mobile communication wireless network, which support playing multimedia ringtone dynamically prior to answer the phone; and
a multimedia ringtone server connecting with the mobile communication network, to provide setting and management of the personal dynamic multimedia ringtone resources; database for managing dynamic multimedia ringtone resources and user's information; and multimedia ringtone medium stream, or multimedia files, or uniform resources location (URL) for mobile phone terminals as the request of playing multimedia ringtone.

Accordingly, the mobile communication network is 3G mobile communication network, or IP multimedia system (IMS).

Accordingly, the session message can be a paging message, a setup message, or a data transmission CP DATA message.

A fixed phone communication system where phone terminal plays multimedia ringtone dynamically prior to answer the phone, comprising:
a telecom fixed communication network, providing the communicating connection between the fixed telephone terminals;
a fixed communication access gateway, connecting the telecom fixed communication network and fixed phone line terminals, to provide the service of connecting fixed phone line terminals to the telecom fixed communication network;
a plurality of fixed phone line terminals connected with the fixed communication access gateway, which support playing multimedia ringtone dynamically prior to answer the phone; and
a multimedia ringtone server connecting with the telecom fixed communication network, to provide setting and management of the personal dynamic multimedia ringtone resources; database for managing dynamic multimedia ringtone resources and user's information; and multimedia ringtone medium stream, or multimedia files, or uniform resources location (URL) for fixed phone line terminals as the request of playing multimedia ringtone.

A method for a called phone number terminal to play ringtone dynamically before answer the call, comprises the following steps.
(a) Receive a session message by the phone terminal P from the communication network.
(b) Determine whether the session message contains multimedia ringtone service flag section by the phone terminal P.
(c) Process step (e) if the session message does not contain multimedia ringtone service flag section.
(d) Obtain the multimedia ringtone resource from the resource address designated by the multimedia ringtone service flag section, and play the multimedia ringtone instead of playing the preset ringtone stored in the phone terminal P, and going to step W.
(e) Play the preset ringtone stored in the phone terminal P.
(f) Execute following standard communication process by the phone terminal P to answer the phone.

Accordingly, in the step (a), the communication network is the third generation mobile communication network, or IP multimedia system (IMS).

Accordingly, in the step (d), the resource address is the URL, IP address and port number, or the IP address and port number and the multimedia ringtone coding type set in the phone terminal P.

Accordingly, in the step (d), the multimedia ringtone resources obtained by the phone terminal P is the medium stream.

A method for a called phone number terminal to play ringtone dynamically based on the setting thereof prior to answer the phone, comprises the following steps.
(a) Receive a session message by the phone terminal from the communication network.
(b) Determine whether the phone terminal has the setting of multimedia ringtone network.
(c) Process step (e) if the phone terminal does not contain the setting of multimedia ringtone network.
(d) Obtain the multimedia ringtone resource from the resource address designated by the user, and play the multimedia ringtone instead of playing the preset ringtone stored in the phone terminal, and going to step (f).
(e) Play the preset ringtone stored in the phone terminal.
(f) Execute following standard communication process to answer the phone.

The present invention provides the user of the phone terminals, especially the users of 3G mobile communication terminals a novel dynamic multimedia ringtone service, enable the users of broadband phone terminals to enjoy the multimedia ringtone message from the network by their phone terminals.

These and other objectives, features, and advantages of the present invention will become apparent from the following detailed description, the accompanying drawings, and the appended claims.

### BRIEF DESCRIPTION OF THE DRAWINGS

FIG. 1 is an architectural diagram of the system of called phone terminal to play ringtone dynamically thereof before answer a call.

FIG. 2 is an architectural diagram of the system of called phone terminal on a mobile network to play ringtone dynamically thereof before answer a call.

FIG. 3 is an architectural diagram of the system of called phone terminal on a fixed network to play ringtone dynamically thereof before answer a call.

FIG. 4 is an architectural diagram of the first embodiment of the present invention.

FIG. 5 is a float diagram illustrating the process of an IMS phone terminal dynamically playing multimedia ringtone before answer a phone call.

FIG. 6 is a float diagram illustrating the process of an IMS phone terminal dynamically playing multimedia ringtone when receive a short message (SMS) or multimedia message.

FIG. 7 is a float diagram illustrating the process of a IMS phone terminal dynamically playing multimedia ringtone when login to a IMS sub-system.

FIG. 8 is an architectural structure diagram of the second embodiment of the present invention.

FIG. 9 is a float diagram illustrating the process of a mobile phone terminal dynamically playing multimedia ringtone before answer a phone call.

FIG. 10 is a float diagram illustrating the process of a mobile phone terminal dynamically playing multimedia ringtone when receive a short message (SMS) or multimedia message.

### DETAILED DESCRIPTION OF THE PREFERRED EMBODIMENT

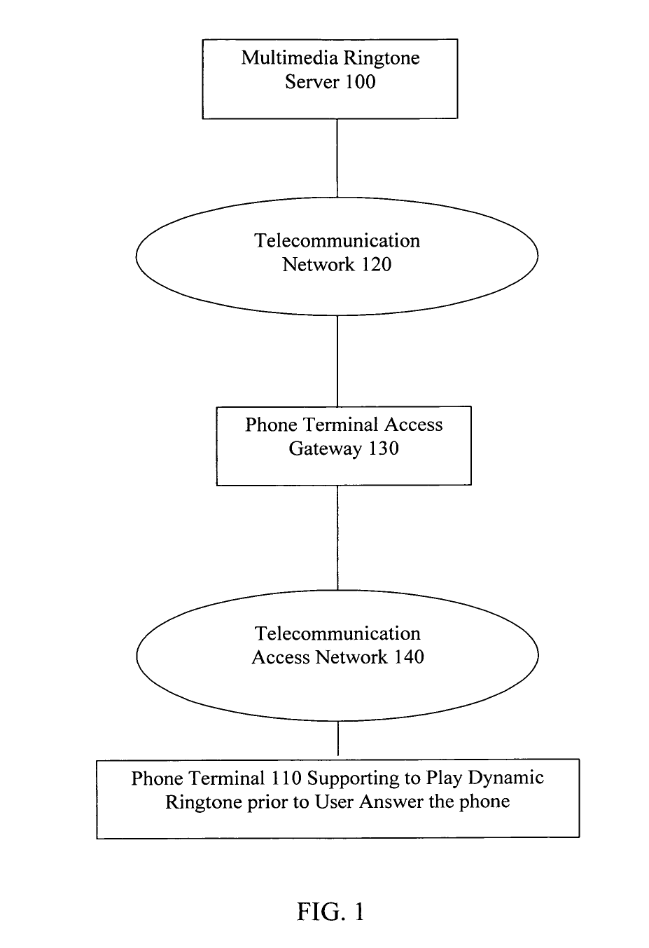

Referring to FIG. 1 of the drawings, an architectural diagram of a called phone number terminal of a system is illustrated, wherein the called phone number terminal is adapted to play a multimedia ringtone dynamically prior to answer the phone. A multimedia ringtone server 100 is communicatively connected with a phone terminal 110 which plays ringtone dynamically prior to answer the phone through a telecommunication network 120, a phone terminal access gateway 130, and a telecommunication access network 140. Preferably, the system provides the phone terminal 110 access management service such as WAP, WEB, IVR, SMS. Preferably, the signaling protocol of accessing the multimedia ringtone from the multimedia ringtone server 100 is SIP, the multimedia transport protocol is RTP, and the multimedia transport control protocol is RTCP.

The phone terminal 110, which plays ringtone dynamically before answer the call, is a phone terminal with a dynamic ringtone function added on a standard phone terminal. The dynamic ringtone system is a dynamic ringtone function, wherein when the user receives the session message from the telecommunication network 120,130,140, the dynamic ringtone system determines whether the session message contains multimedia ringtone service flag section. For the session message which contains multimedia ringtone service flag, the multimedia ringtone information is obtained from the target address designated to play the multimedia ringtone at the phone terminal 110. Therefore, the phone terminal 110 will play the multimedia ringtone instead of playing the preset ringtone at the phone terminal 110. For the session message which does not contain multimedia ringtone service flag, the phone terminal 110 will play the preset ringtone saved in the phone terminal 110 by the user.

A method for a called phone number terminal to play ringtone dynamically before answer the call, comprising the steps of:
(a) receiving a session message by the phone terminal 110 from the communication network 120;
(b) determining whether the session message contains multimedia ringtone service flag section by the phone terminal 110;
(c) processing step (e) if the session message does not contain multimedia ringtone service flag section;
(d) obtaining the multimedia ringtone resource from the resource address designated by the multimedia ringtone service flag section and playing the multimedia ringtone instead of playing the preset ringtone stored in the phone terminal 110, and going to step (f);
(e) playing the preset ringtone stored in the phone terminal 110;
(f) executing following standard communication process by the phone terminal 110 to answer the call.

Accordingly, in the step (a), the communication network 120 is the third generation mobile communication network, or IP multimedia system (IMS).

Accordingly, in the step (a), the session message is a paging message, a call setup message, or a data transmission CP DATA message.

Accordingly, in the step (d), the resource address is the URL, IP address and port number, or the IP address and port number and the multimedia ringtone coding type set in the phone terminal 110.

Accordingly, in the step (d), the multimedia ringtone resources obtained by the phone terminal 110 is the medium stream.

A method for a called phone number terminal to play ringtone dynamically based on the setting thereof prior to answer the phone, comprising the steps of:
(a) receiving a session message by the phone terminal 110 from the communication network 120;
(b) determining whether the phone terminal 110 has the setting of multimedia ringtone network;
(c) processing step (e) if the phone terminal 110 does not contain the setting of multimedia ringtone network;
(d) obtaining the multimedia ringtone resource from the resource address designated by the user and playing the multimedia ringtone instead of playing the preset ringtone stored in the phone terminal 110, and going to step (f);
(e) playing the preset ringtone stored in the phone terminal 110;
(f) executing following standard communication process to answer the call.

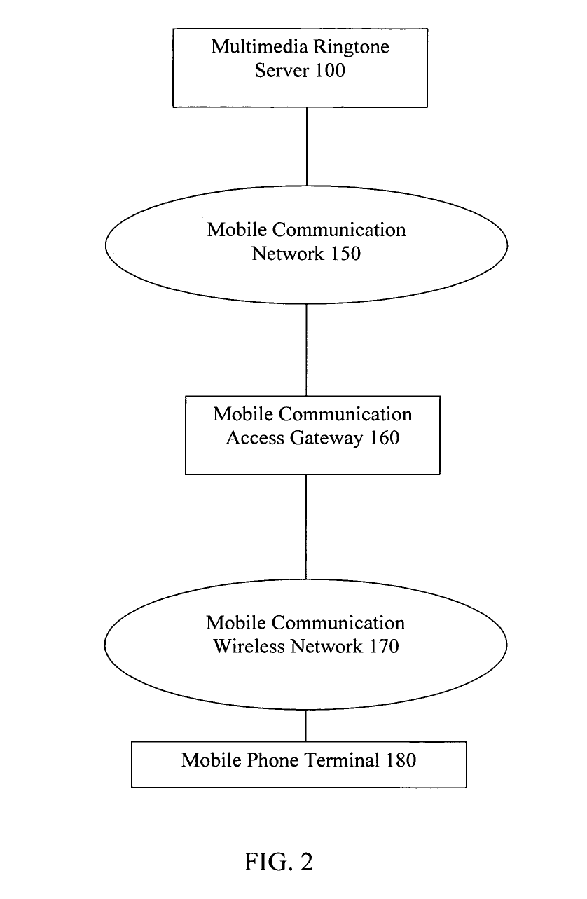

Referring to FIG. 2, which is an architectural diagram of the system of called phone number terminal on a mobile network to play multimedia ringtone dynamically thereof prior to answer the phone. A multimedia ringtone server 100 is connected with the mobile phone terminal 180 which plays multimedia ringtone dynamically prior to answer the phone through the mobile communication network 150, the mobile communication access gateway 160, and the mobile communication wireless network 170. Preferably, the mobile phone terminal 180 uses protocol such as WAP, WEB, IVR, SMS to access the multimedia ringtone server 100. Preferably, the signaling protocol of accessing the multimedia ring from the multimedia ringtone server 100 is SIP, the multimedia transport protocol is RTP, and the multimedia transport control protocol is RTCP.

A mobile communication system where mobile phone terminal plays multimedia ringtone dynamically prior to answer the phone, comprising:
a mobile communication network 150 providing communication links between mobile phone terminals;
a mobile communication access gateway 160, connecting the mobile communication wireless network 170 and the mobile communication network 150, to provide the service of communicatively connecting mobile phone terminals 180 to the mobile communication network 150 via mobile communication wireless network 170;
a plurality of mobile phone terminals 180 connected with the mobile communication access gateway 160 via mobile communication wireless network 170, which support playing multimedia ringtone dynamically prior to answer the phone; and
a multimedia ringtone server 100 connecting with the mobile communication network 150, to provide setting and management of the personal dynamic multimedia ringtone resources; database for managing dynamic multimedia ringtone resources and user's information; and multimedia ringtone medium stream, or multimedia files, or uniform resources location (URL) for mobile phone terminals as the request of playing multimedia ringtone.

Accordingly, the mobile communication network 150 is 3G mobile communication network, or IP multimedia system (IMS).

Accordingly, the session message can be a paging message, a setup message, or a data transmission CP DATA message.

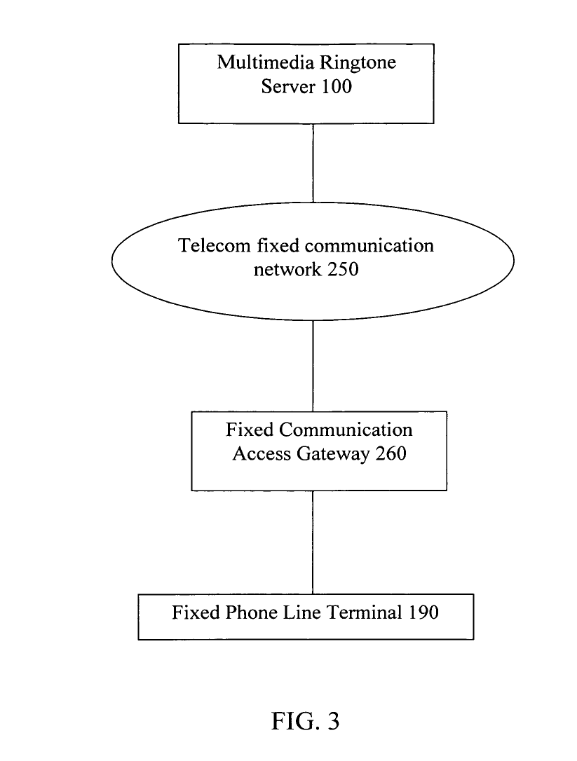

Referring to FIG. 3, which is an architectural diagram of the system of called phone number terminal on a fixed network to play multimedia ringtone dynamically thereof prior to answer the phone, the multimedia ringtone server 100 is connected with the fixed phone line terminal 190 which plays multimedia ringtone dynamically prior to answer the phone through the telecom fixed communication network 250, and the fixed communication access gateway 260. Preferably, the fixed phone line terminal 190 uses protocol such as WAP, WEB, IVR, SMS to access the multimedia ringtone server 100. Preferably, the signaling protocol of accessing the multimedia ring from the multimedia ringtone server 100 is BICC, the multimedia transport protocol is RTP, and the multimedia transport control protocol is RTCP.

A fixed phone communication system where phone terminal plays multimedia ringtone dynamically prior to answer the phone, comprising:
a telecom fixed communication network 250, providing the communicating connection between the fixed telephone terminals;
a fixed communication access gateway 260, connecting the telecom fixed communication network 250 and fixed phone line terminals 190, to provide the service of connecting fixed phone line terminals to the telecom fixed communication network 250;
a plurality of fixed phone line terminals 190 connected with the fixed communication access gateway 260, which support playing multimedia ringtone dynamically prior to answer the phone; and
a multimedia ringtone server 100 connecting with the telecom fixed communication network 250, to provide setting and management of the personal dynamic multimedia ringtone resources; database for managing dynamic multimedia ringtone resources and user's information; and multimedia ringtone medium stream, or multimedia files, or uniform resources location (URL) for fixed phone line terminals 190 as the request of playing multimedia ringtone.

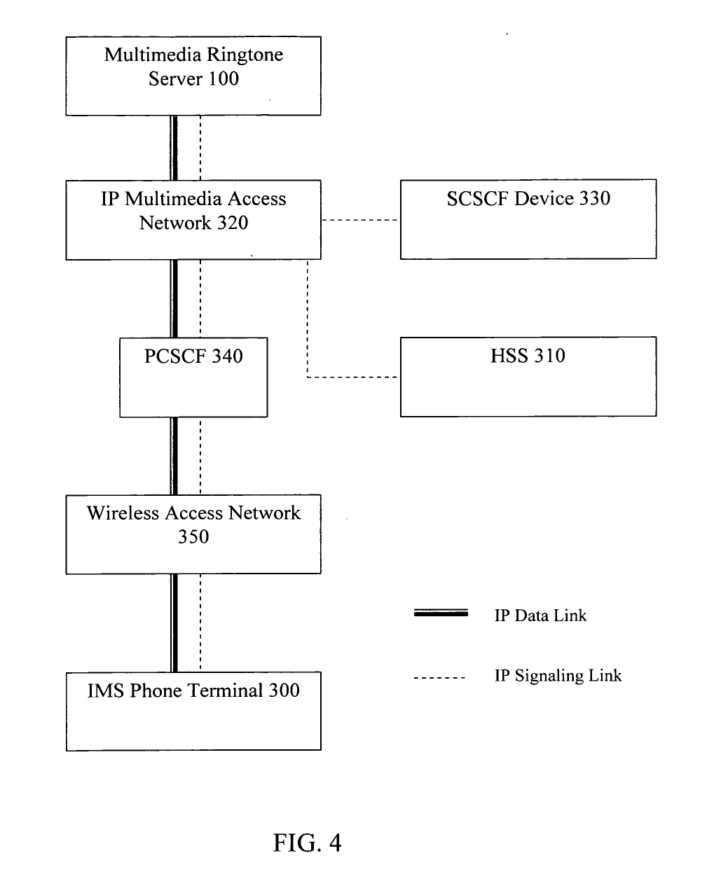

FIG. 4 is a system structure diagram of the first embodiment of the present invention. The system is realized on the IMS of third generation mobile communication. It comprises multimedia ringtone server 100, IP multimedia access network 320, call session control function proxy module (PCSCF) 340, wireless access network 350, and IMS phone terminal 300 which are connected in series. The connection includes IP data link, and IP signaling link. The IP multimedia access network 320 is connected with the PCSCF device 330 and home subscriber server (HSS) 310 though IP signaling link, wherein:
1. IMS phone terminal 300 is an IMS terminal which supports playing multimedia ringtone dynamically prior to answer the phone.
2. HSS 310 manages the user's dynamic play ring service flag section and multimedia resource location section;
3. The user's number of the IMS phone terminal 300 in the HSS 310 is the dynamically playing ringtone service (dynamic ring) customer; the location of the multimedia ringtone resource assigned to the IMS phone terminal 300 user's number by the HSS 310 is the IP address and port number of the multimedia ringtone server 100;
4. After the IMS phone terminal 300 user's number set the dynamic ring service in its HS S 310, the HS S 310 automatically transfers the information of the user's dynamic play ringtone service flag section and multimedia resource location section to the SCSCF 330 which the user number belongs to;
5. Use SIP protocol as the call signaling messages.

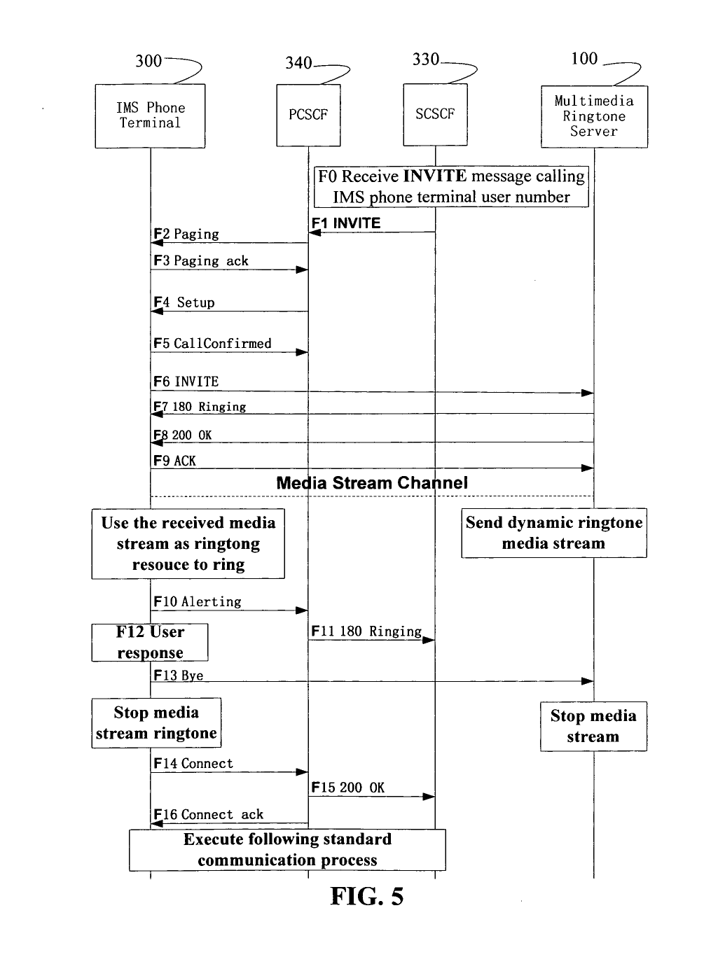

FIGS. 5, 6, and 7 illustrate the process of dynamic multimedia ringtone of the first embodiment of the present invention when the IMS phone terminal 300 is called, receives SMS, or multimedia message, and login.

Referring to FIG. 5, the process of the IMS phone terminal 300 dynamically playing ringtone prior to answer the phone, comprises the steps of:

F0: SCSCF 330 receives the initial call message INVITE calling the IMS phone terminal 300 user number;

F1: SCSCF 330 sends INVITE message to PSCSCF 340 where IMS phone terminal 300 is located. The INVITE message contains the user's dynamic play ringtone service flag section and multimedia resource location section. The multimedia resource location section has the IP address and port number of the multimedia ringtone server 100. Preferably, the number called by the INVTE message consists “ringservice=YES, ringserver=211.97.170.49:9000”, wherein the “ringservice” is the dynamic playing ringtone service flag section, the “ringserver” is the multimedia ring resource location section;

F2-F3: PSCSCF 340 pages IMS phone terminal 300;

F4-F5: PSCSCF 340 starts the initial session message, wherein the setup message contains the information of dynamic play ringtone service flag section and multimedia resource location section in the INVITE message;

F6-F9: IMS phone terminal 300 setup the multimedia connection with the multimedia ringtone server 100, and used the received multimedia stream as the IMS phone terminal 300 ringtone;

F10-F11: IMS phone terminal 300 returns a ringtone message to the caller;

F12-F16: IMS phone terminal 300 user answers the call, and IMS phone terminal 300 turns off the connection with the multimedia ringtone server 100, sends the answer message to the caller, and executes the following standard communication processes.

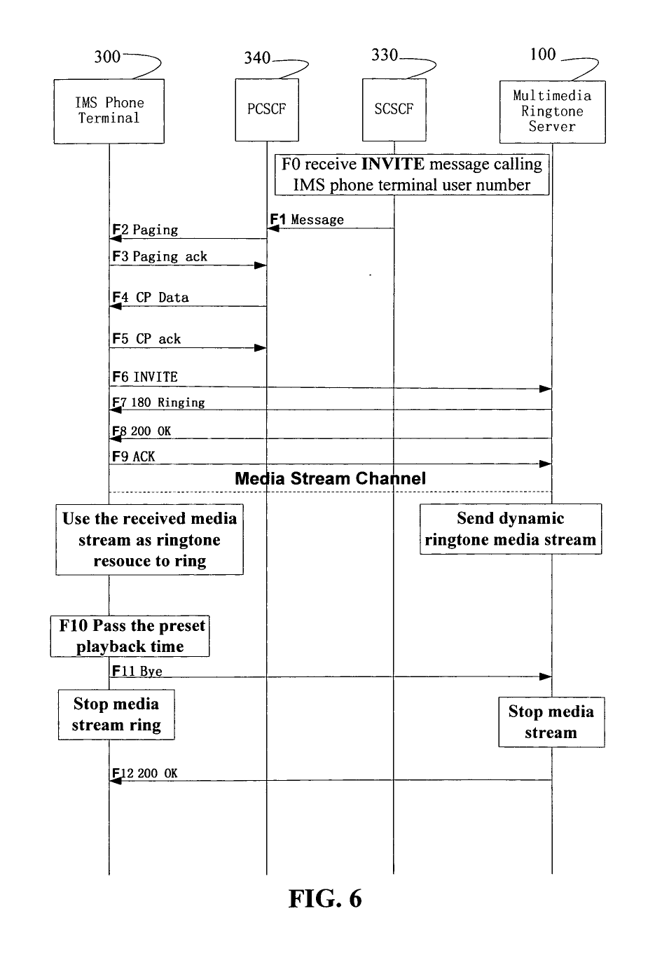

Referring to FIG. 6, the process of the IMS phone terminal 300 dynamically playing ringtone when receives a SMS or multimedia message, comprises steps of:

F0: SCSCF 330 receive the instruction message of a SMS or multimedia message to the IMS phone terminal 300 user number;

F1: SCSCF 330 send the message to PSCSCF 340 where IMS phone terminal 300 is located. The INVITE message contains the user's dynamic play ringtone service flag section and multimedia resource location section. The multimedia resource location section has the IP address and port number of the multimedia ringtone server 100.

Preferably, the number called by the message consists “ringservice=YES, ringserver=211.97.170.49:9000”, wherein the “ringservice” is the dynamic playing ring service flag section, the “ringserver” is the multimedia ring resource location section;

F2-F3: PSCSCF 340 pages IMS phone terminal 300;

F4-F5: PSCSCF 340 starts the message send session, wherein the CP data message contains the information of dynamic play ringtone service flag section and multimedia resource location section in the message;

F6-F9: IMS phone terminal 300 setup the multimedia connection with the multimedia ringtone server 100, and used the received multimedia stream as the IMS phone terminal 300 ringtone;

F10-F11: IMS phone terminal 300 returns a ringtone message to the caller;

F12-F16: IMS phone terminal 300 plays the dynamic ringtone for a predetermined period of time, and then stops playing.

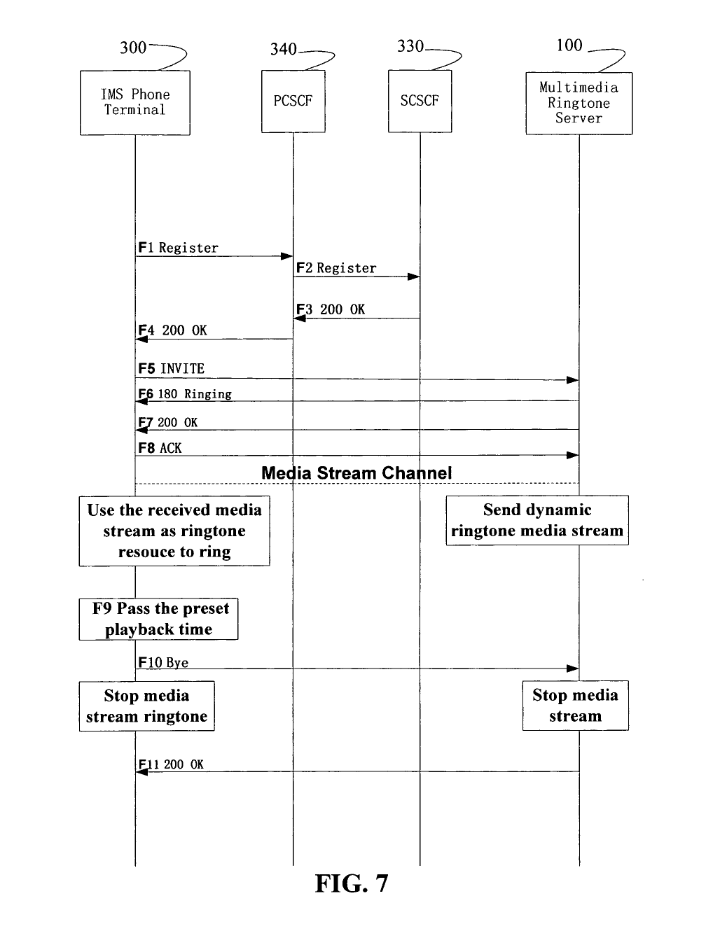

Referring to FIG. 7, the process of the IMS phone terminal 300 dynamically playing ring when login to IMS, comprises steps of:

F0: SCSCF 330 receive the Register message the IMS phone terminal 300 user number;

F1-F3: SCSCF 330 send “200 OK” message to PSCSCF 340 where IMS phone terminal 300 is located. The “200 OK” message contains the user's dynamic play ringtone service flag section and multimedia resource location section. The multimedia resource location section has the IP address and port number of the multimedia ringtone server 100. Preferably, the number called by the “200 OK” message consists “ringservice=YES, ringserver=211.97.170.49:9000”, wherein the “ringservice” is the dynamic playing ringtone service flag section, the “ringserver” is the multimedia ring resource location section;

F4: PSCSCF 340 forwards the “200 OK” message to IMS phone terminal 300, wherein “200 OK” message contains the user's dynamic play ringtone service flag section and multimedia resource location section.

F5-F8: IMS phone terminal 300 setup the multimedia connection with the multimedia ringtone server 100, and used the received multimedia stream as the IMS phone terminal 300 ringtone;

F9-F11: IMS phone terminal 300 plays the dynamic ringtone for a predetermined period of time, and then stops playing.

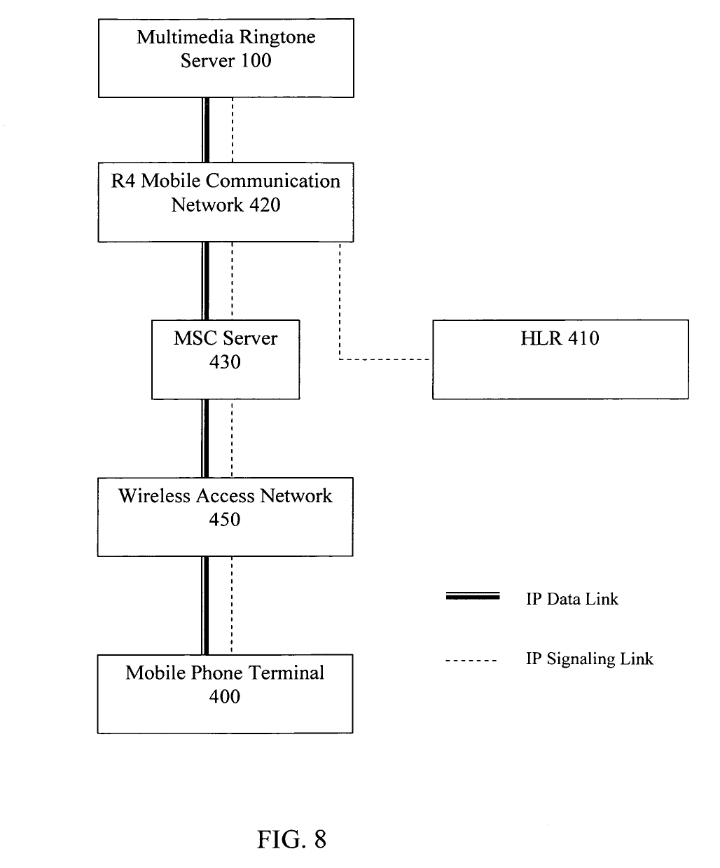

FIG. 8 is an architectural diagram of the second embodiment of the present invention. The system is realized on the R4 network system of the third generation mobile communication. It comprises:
1. Mobile phone terminal 400 is a mobile phone terminal which supports playing ringtone dynamically prior to answer the phone.
2. Home location register (HLR) 410 manages the user's dynamic play ringtone service flag section and multimedia resource location section;
3. The user's number of the mobile phone terminal 400 in the HLR 410 is the dynamically playing ringtone service (dynamic ringtone) customer; the location of the multimedia ringtone resource assigned to the mobile phone terminal 400 user's number by the HLR 410 is the IP address and port number of the multimedia ringtone server 100;
4. After the mobile phone terminal 400 user's number set the dynamic ringtone service in its HLR 410, the HLR 410 automatically transfers the information of the user's dynamic play ringtone service flag section and multimedia resource location section to the MSC Server 430 which the user number belongs to;
5. Use MAP protocol as the mobile application signaling messages, use BICC as the protocol for carrying voice call signaling message;
6. Add “ringSubscriberData” section to the MAP signaling, use GPRSDataList as data structure, use pdp-Type section as the dynamic play ring service flag section, use the pdp-Address section as the multimedia resource location section;
7. When receiving the “ringSubscriberData” section within the “SendRoutingInfo ack”, MSC Server uses the “User-to-user information” section of the calling message ISUP or BICC to carry “ringSubscriberData” section in the initial asking message (IAM) of the called number.

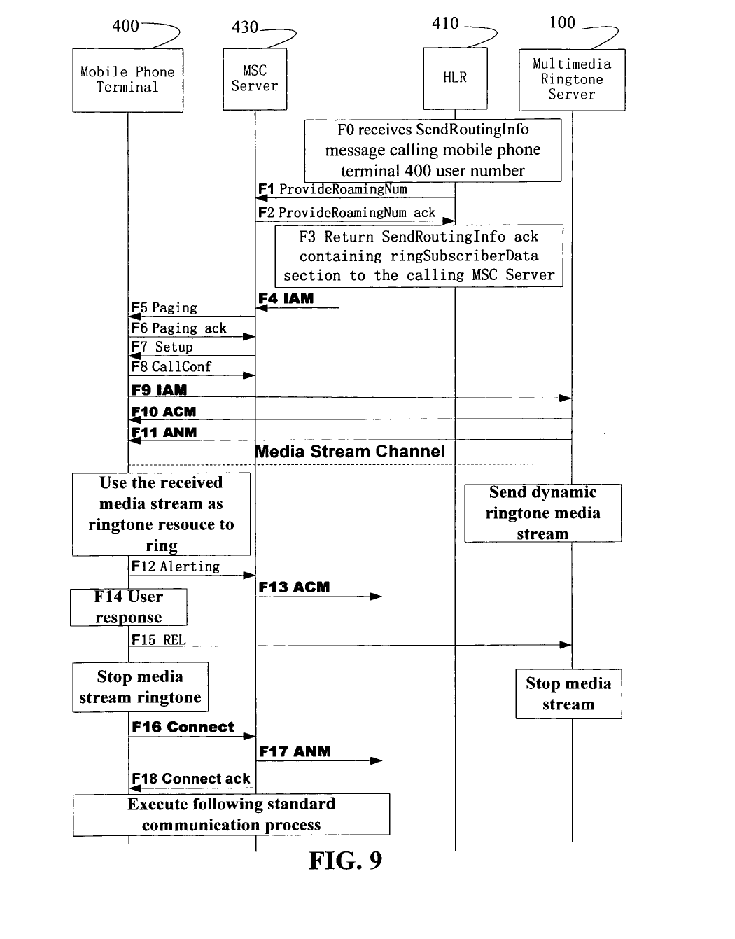

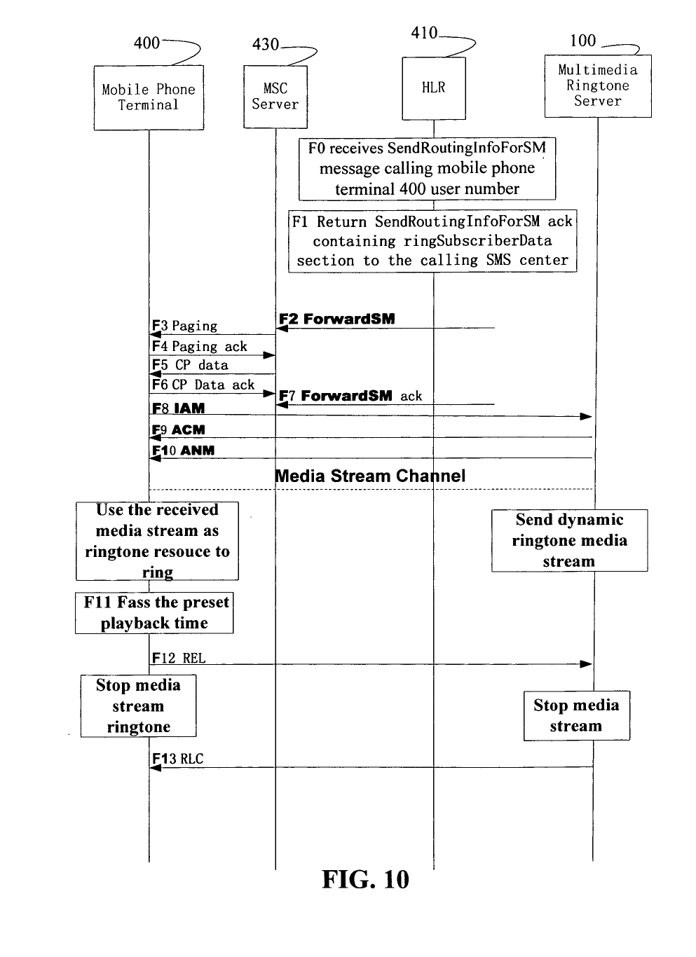

FIGS. 9 and 10 illustrate the process of dynamic multimedia ringtone of the second embodiment of the present invention when the mobile phone terminal 400 is called, receives SMS, or multimedia message. In other words, the session message can be a voice data, a voice message, text message, or multimedia message.

Referring to FIG. 9, the process of the mobile phone terminal 400 dynamically playing ring prior to answer the phone, comprises steps of:

F0-F3: HLR 410 receives the SendRoutinglnfo message calling the mobile phone terminal 400 user number; after checking the roaming number in the MSC Server 430 where the mobile phone terminal 400 is, return an answer message containing the “ringSubscriberData” section to the MSC Server 430 who start the call; preferably in the “ringSubscriberData” section, pdp-type=1; and pdp-address=211.97.170.49:9000; wherein the pdp-Type section is the dynamic play ringtone service flag section, the pdp-Address section is the multimedia resource location section.

F4: MSC Server 430 receives the IAM wherein the target number is the mobile phone terminal 400. The “User-to-user information” section of the IAM message contains the user's dynamic play ring service flag section and multimedia resource location section. The multimedia resource location section has the IP address and port number of the multimedia ringtone server 100;

F5-F6: MSC Server 430 pages mobile phone terminal 400;

F7-F8: MSC Server 430 starts the initial call session to the mobile phone terminal 400, wherein the setup message contains the information of dynamic play ringtone service flag section and multimedia resource location section in the IAM message;

F9-F11: mobile phone terminal 400 setup the multimedia connection with the multimedia ringtone server 100, and used the received multimedia stream as mobile phone terminal 400 ringtone;

F12-F13: mobile phone terminal 400 returns a ringtone message to the caller;

F14-F18: mobile phone terminal 400 user answers the call, and mobile phone terminal 400 turns off the connection with the multimedia ringtone server 100, sends the answer message to the caller, and executes the following standard communication processes.

Referring to FIG. 10, the process of the mobile phone terminal 400 dynamically playing ringtone when receives a SMS, comprises steps of:

F0-F1: HLR 410 receives the SendRoutinglnfoForSM message to the mobile phone terminal 400 user number; returns an answer message containing the “ringSubscriberData” section to the SMS center who sent the SMS; preferably in the “ringSubscriberData” section, pdp-type=1; and pdp-address=211.97.170.49:9000; wherein the pdp-Type section is the dynamic play ring service flag section, the pdp-Address section is the multimedia resource location section.

F2: MSC Server 430 receives the short message instruction ForwardSM to the mobile phone terminal 400. The ForwardSM message contains the user's dynamic play ringtone service flag section and multimedia resource location section. The multimedia resource location section has the IP address and port number of the multimedia ringtone server 100, preferably the ForwardSM message contains “ringSubscriberData” section;

F3-F4: MSC Server 430 pages mobile phone terminal 400;

F5-F6: MSC Server 430 starts the initial call session to the mobile phone terminal 400, wherein the CP data message contains the information of dynamic play ringtone service flag section and multimedia resource location section in the ForwardSM message;

F7-F10: mobile phone terminal 400 setup the multimedia connection with the multimedia ringtone server 100, and used the received multimedia stream as mobile phone terminal 400 ringtone;

F11-F13: mobile phone terminal 400 plays the dynamic ringtone for a predetermined period of time, and then stops playing the ringtone.

The above embodiments are also adapted to IP communication terminals on the IP access networks such as INTENET, WiMAX, WiFi, etc.

The above embodiments are also adapted to GSM and CDMA mobile communication system, the detail differences are not discussed here.

It is worth mentioning, in the above embodiments, the phone terminal obtains network multimedia ring resource through establishing the multimedia data stream channel with the multimedia ringtone server 100. The phone terminal is also able to obtain multimedia ringtone resource through USSD, MSRP (Message Session Relay Protocol), etc. Especially for GSM system, the phone terminal can obtain the text type of ringtone resource from the multimedia ringtone server 100 in USSD mode.

It is worth mentioning, the multimedia dynamic ringtone user A can set or reserve multimedia ringtone resource and play sequence on the multimedia ringtone server 100 via WEB/WAP/IVR/SMS, and set different multimedia ringtone or resources according to the calling number or message number; what's more, with the allowance of user A, user B can set the dynamic ringtone or ringtone resource on user A's phone terminal when user B call or send message to user A.

It is worth mentioning, the following content is also included in the present invention: the phone terminal which plays ringtone dynamically prior to answer the phone needs to have the additional menu: start dynamic multimedia network ringtone service, stop dynamic multimedia network ringtone service, set multimedia ringtone server network address. If the user actives the menu option of “start dynamic multimedia network ring service”, when the phone terminal which plays ringtone dynamically prior to answer the phone receives an IAM message, it will setup the connection with the multimedia ringtone server according to the menu option “set multimedia ringtone server network address”, and use the media stream obtained from the multimedia ringtone server to replace the preset ringtone stored in the phone terminal. If the user actives the menu option of “stop dynamic multimedia network ringtone service”, when the phone terminal which plays ringtone dynamically prior to answer the phone receive an IAM message, it will play the preset ringtone stored in the phone terminal.

It is worth mentioning, if multimedia ringtone server only allows starting dynamic multimedia network ringtone service through network, and if the phone terminal which plays ringtone dynamically prior to answer the phone receives a IAM message containing the user's dynamic play ringtone service flag section but not the multimedia resource location section, the phone terminal setup the connection to the multimedia ringtone server using the menu option of “set multimedia ring server network address”.

It is worth mentioning, the following content is also included in the present invention: if multimedia ringtone server only allows the phone terminal to start dynamic multimedia network ringtone service directly, no matter the phone terminal which plays ringtone dynamically prior to answer the phone receives a IAM message which contains the user's dynamic play ringtone service flag section or not, the phone terminal will setup the connection to the multimedia ringtone server using the menu option of “set multimedia ringtone server network address”.

It is worth mentioning, the following content is also included in the present invention: when the mobile phone powers on and receives the message of login mobile communication network successfully, it will check the multimedia ringtone server for unanswered call automatically. If there is unanswered call, the phone terminal will play special dynamic ringtone to indicate the details of the unanswered call during the period of power off. If there is unanswered SMS or multimedia message, the phone terminal will play special dynamic ringtone to indicate the details of the unanswered message during the period of power off. If there is no unanswered call of message, the multimedia ringtone server will provide the mobile phone a piece of greeting message.

It is worth mentioning, in the embodiment of the present invention, the multimedia ringtone server provides ringtone resources by media stream. Using URL to provide media resource location is easy to realize and will not describe in detail here.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A phone terminal, comprising:
means for receiving a session message from a communication network; and
a dynamic ringtone system determining whether said session message contains a multimedia ringtone service flag section, wherein when said session message contains said multimedia ringtone service flag, said phone terminal receives said session message with a multimedia ringtone, such that said phone terminal is set to play said multimedia ringtone prior to answer the phone, wherein when said session message does not contain said multimedia ringtone service flag, said phone terminal is set to play a preset ringtone stored therein prior to answer the phone.

2. The phone terminal, as recited in claim 1, wherein said dynamic ringtone system comprises a menu option arranged in such a manner that when said menu option is set to start dynamic multimedia network ring service, said receiving means receives said session message with said multimedia ringtone, such that said phone terminal plays said multimedia ringtone prior to answer the phone, wherein when said menu option is set to stop dynamic multimedia network ring service, said phone terminal is set to play said preset ringtone stored therein prior to answer the phone.

3. A communication system, comprising:
a communication network;
a plurality of phone terminals communicatively linking with said communication network, wherein each of said phone terminals comprises means for receiving a session message from a communication network, and a dynamic ringtone system determining whether said session message contains a multimedia ringtone service flag section; and
a multimedia ringtone server, connecting with said communication network for each of said phone terminals, comprising a setting and management of a personal dynamic multimedia ringtone resources, database for managing dynamic multimedia ringtone resources and user's information, and multimedia ringtone medium stream for said phone terminals as a request of playing multimedia ringtone, wherein when said session message contains said multimedia ringtone service flag, said multimedia ringtone server sends out a multimedia ringtone dynamically to said phone terminal with said session message, such that said phone terminal is set to play said multimedia ringtone prior to answer the phone, wherein when said session message does not contain said multimedia ringtone service flag, said phone terminal is set to play a preset ringtone stored therein before answer said call.

4. The communication system, as recited in claim 3, wherein said communication system is selected from the group consisting of 3G mobile communication network, IP multimedia system (IMS), and a telecom fixed communication network.

5. The communication system, as recited in claim 4, wherein said session message is one of paging message and setup message.

6. The communication system, as recited in claim 5, wherein said session message is selected from the group consisting of voice data, voice message, text message, and multimedia message.

7. The communication system, as recited in claim 3, wherein said multimedia ringtone server further comprises a menu option provided at each of said phone terminals and arranged in such a manner that when said menu option is set to start dynamic multimedia network ring service, said multimedia ringtone server sends out said multimedia ringtone with said session message dynamically to said phone terminal, such that said phone terminal is set to play said multimedia ringtone prior to answer the phone, wherein when said menu option is set to stop dynamic multimedia network ring service, said phone terminal is set to play said preset ringtone stored therein before answer said call.

8. The communication system, as recited in claim 6, wherein said multimedia ringtone server further comprises a menu option provided at each of said phone terminals and arranged in such a manner that when said menu option is set to start dynamic multimedia network ring service, said multimedia ringtone server sends out said multimedia ringtone with said session message dynamically to said phone terminal, such that said phone terminal is set to play said multimedia ringtone prior to answer the phone, wherein when said menu option is set to stop dynamic multimedia network ring service, said phone terminal is set to play said preset ringtone stored therein before answer said call.

9. A method of playing a multimedia ringtone dynamically by a phone terminal prior to answer the phone, comprising the steps of:
(a) receiving a session message by said phone terminal from a communication network;
(b) determining whether said session message contains multimedia ringtone service flag section;
(c) when said session message contains multimedia ringtone service flag section, obtaining a multimedia ringtone resource from a resource address designated by a user of said phone terminal and playing said multimedia ringtone; and
(d) executing a standard communication process to answer said call.

10. The method as recited in claim 9 wherein, in the step (c), when session message does not contain multimedia ringtone service flag section, playing a preset ringtone stored in said phone terminal.

11. The method, as recited in claim 10, wherein said communication system is selected from the group consisting of 3G mobile communication network, IP multimedia system (IMS), and a telecom fixed communication network.

12. The method, as recited in claim 10, wherein, in step (c), said resource address is the URL, IP address and port number, or the IP address and port number and the multimedia ring coding type set in said phone terminal.

13. The method, as recited in claim 11, wherein, in step (c), said resource address is the URL, IP address and port number, or the IP address and port number and the multimedia ring coding type set in said phone terminal.

14. The method, as recited in claim 10, wherein, in step (c), said multimedia ringtone resources obtained by said phone terminal is medium stream.

15. The method, as recited in claim 13, wherein, in step (c), said multimedia ringtone resources obtained by said phone terminal is medium stream.

16. The method as recited in claim 10, wherein in step (a), the session message is selected from the group consisting of a paging message, a call setup message, and a data transmission CP DATA message.

17. The method as recited in claim 15, wherein in step (a), the session message is selected from the group consisting of a paging message, a call setup message, and a data transmission CP DATA message.

18. The method, as recited in claim 10, before the step (a), further comprising a step of setting a menu option for dynamic multimedia network ring service of said phone terminal, wherein when said menu option is set to start dynamic multimedia network ring service, said phone terminal plays said multimedia ringtone prior to answer the phone, wherein when said menu option is set to stop dynamic multimedia network ring service, said phone terminal is set to play said preset ringtone stored therein prior to answer the phone.

19. The method, as recited in claim 17, before the step (a), further comprising a step of setting a menu option for dynamic multimedia network ring service of said phone terminal, wherein when said menu option is set to start dynamic multimedia network ring service, said phone terminal plays said multimedia ringtone prior to answer the phone, wherein when said menu option is set to stop dynamic multimedia network ring service, said phone terminal is set to play said preset ringtone stored therein prior to answer the phone.

20. (canceled)

21. A method for a called phone number terminal to play ringtone dynamically based on the setting thereof prior to answer the phone, comprising the steps of:
(a) receiving a session message by a phone terminal from a communication network;
(b) determining whether said phone terminal has the setting of network multimedia ringtone;
(c) when said phone contains the setting of network multimedia ringtone, obtaining a multimedia ringtone resource from a resource address designated by setting of said phone terminal, and playing said multimedia ringtone;
(d) when said phone does not contain the setting of network multimedia ringtone, playing a preset ringtone stored in said phone terminal; and
(e) executing a standard communication process to answer the phone.
